(19) United States
(12) Patent Application Publication
(10) Pub. No.: US 2024/0336238 A1
(43) Pub. Date: Oct. 10, 2024

(54) ELECTRO-MECHANICAL BRAKE SYSTEM AND CONTROL METHOD THEREOF

(71) Applicant: HL MANDO CORPORATION, Gyeonggi-do (KR)

(72) Inventor: Sera Hyeon, Gyeonggi-do (KR)

(21) Appl. No.: 18/385,393

(22) Filed: Oct. 31, 2023

(30) Foreign Application Priority Data
Apr. 7, 2023 (KR) 10-2023-0045855

(51) Int. Cl. B60T 1/00; B60T 7/12; B60T 8/17; B60T 13/74; B60T 17/22; F16D 65/18; F16D 66/00

(52) U.S. Cl. CPC B60T 1/005; B60T 7/12; B60T 8/17; B60T 13/746; B60T 17/22; F16D 65/18; F16D 66/00; F16D 2066/005; F16D 2066/006; F16D 2121/24; F16D 2125/40; F16D 2127/06

(57) ABSTRACT

A brake device according to an embodiment of the present disclosure includes a power transmitter configured to advance or retract a piston to press a pair of pad plates, to which brake pads are attached, toward a disk, a driving motor configured to provide rotational force to the piston, a parking actuator connected to the driving motor to maintain parking braking state of a vehicle, and a controller configured to control the driving motor and the parking actuator, and control the parking actuator based on a rotational position of the driving motor and a clamping force due to contact of the disk with the brake pads.

### CROSS-REFERENCE TO RELATED APPLICATION

This application claims the benefit of Korean Patent Application No. 10-2023-0045855, filed on Apr. 7, 2023 in the Korean Intellectual Property Office, the disclosure of which is incorporated herein by reference in its entirety.

### BACKGROUND

### 1. Technical Field

Embodiments of the present disclosure relate to a brake device and control method thereof for implementing braking and parking of a vehicle by the power of a motor.

### 2. Description of the Related Art

In general, electromechanical brake systems apply brake pads to a disk installed on a wheel by moving a piston using a motor and a reducer when the driver's braking intention is detected, thereby braking the wheel.

These electromechanical brake systems require a service brake function to provide braking power in driving situations, as well as a parking brake function to keep the vehicle stationary when parked.

When performing the parking brake function, the torque generated by the motor is increased through the reducer to generate the clamping force required for parking by the mechanical structure inside the caliper, and in order to maintain the generated clamping force, it is necessary to fix the piston against the reaction force from the brake pads, so the rotational force is transmitted from the motor to limit the movement of the reducer that rotates.

Conventionally, the movement of the reducer is limited by using a stop ring that rotates with the rotation shaft of one of the gears that make up the reducer, and a solenoid lever that moves forward and backward by the solenoid and is engaged with a gear provided in the stop ring to constrain the rotation of the rotation shaft where the stop ring is provided.

Since the solenoid lever is engaged with the gear of the stop ring when parking is engaged, it is necessary to apply more force to rotate the stop ring than the position of the stop ring when parking is engaged to release the solenoid lever when parking is released.

However, if the engagement and release speeds are set to high to shorten the parking operation time, a problem may occur where the solenoid lever may be engaged under excessive torque due to motor inertia when engaging, or the solenoid lever may not be released when releasing because the motor cannot reach the specified parking release torque.

### SUMMARY

Therefore, it is an aspect of the present disclosure to provide a brake device and control method thereof for implementing braking and parking of a vehicle by the power of a motor.

In accordance with one aspect of the present disclosure a brake device may include a power transmitter configured to advance or retract a piston to press a pair of pad plates, to which brake pads are attached, toward a disk, a driving motor configured to provide rotational force to the piston, a parking actuator connected to the driving motor to maintain parking braking state of a vehicle and a controller configured to control the driving motor and the parking actuator, and control the parking actuator based on a rotational position of the driving motor and a clamping force due to contact of the disk with the brake pads.

The brake device may further include a force sensor configured to detect the clamping force due to contact of the disk with the brake pads.

The brake device may further include a motor current sensor configured to detect a drive current of the driving motor. The controller may estimate the clamping force based on the drive current.

The controller may control the parking actuator to engage when the clamping force reaches a target engagement clamping force in parking engagement mode, and detect and store a position of the driving motor as parking motor position.

The controller may drive the driving motor in a forward direction in parking release mode.

The controller may control the parking actuator to release when the clamping force reaches a target release clamping force in parking release mode.

The target release clamping force may be greater than the target engagement clamping force.

The controller may detect the position of the driving motor in parking release mode, and control the parking actuator to release when the position of the driving motor reaches the parking motor position.

The controller may detect the position of the driving motor in parking release mode when the clamping force reaches the target release clamping force and control the parking actuator to release when the detected position of the driving motor reaches the parking motor position.

The controller may drive the driving motor in a backward direction after controlling the parking actuator to release in parking release mode.

In accordance with another aspect of the present disclosure, a method of controlling a brake device including a power transmitter configured to advance or retract a piston to press a pair of pad plates, to which brake pads are attached, toward a disk, a driving motor configured to provide rotational force to the piston and a parking actuator connected to the driving motor to maintain parking braking state of a vehicle may include obtaining a clamping force resulting from contact of the disk with the brake pads and controlling the parking actuator based on the clamping force and a rotational position of the driving motor.

The obtaining of the clamping force may include obtaining the clamping force through a force sensor configured to detect the clamping force due to contact of the disk with the brake pads.

The obtaining of the clamping force may include detecting a drive current of the driving motor through a motor current sensor and estimating the clamping force based on the drive current.

The controlling of the parking actuator may include controlling the parking actuator to engage when the clamping force reaches a target engagement clamping force in parking engagement mode.

The controlling of the parking actuator may include driving the driving motor in a forward direction in parking release mode.

The controlling of the parking actuator may include controlling the parking actuator to release when the clamping force reaches a target release clamping force in parking release mode.

The target release clamping force may be greater than the target engagement clamping force.

The controlling of the parking actuator may include detecting the position of the driving motor in parking release mode and controlling the parking actuator to release when the position of the driving motor reaches the parking motor position.

The controlling of the parking actuator include detecting the position of the driving motor in parking release mode when the clamping force reaches the target release clamping force and controlling the parking actuator to release when the position of the driving motor reaches the parking motor position.

The controlling of the parking actuator may include driving the driving motor in a backward direction after controlling the parking actuator to release in parking release mode.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating an electromechanical brake system according to one embodiment of the present disclosure;

FIG. 2 is a view illustrating a parking engagement of a parking actuator of the electromechanical brake system according to one embodiment of the present disclosure;

FIG. 3 is a view illustrating a parking release of the parking actuator of the electromechanical brake system according to one embodiment of the present disclosure;

FIG. 4 is a view illustrating motor toque over time during parking engagement and release of the electromechanical brake system according to one embodiment of the present disclosure;

FIG. 5 is a view illustrating a control block of the electromechanical brake system according to one embodiment of the present disclosure;

FIG. 6 is a view illustration a control method for parking engagement of the electromechanical brake system according to one embodiment of the present disclosure; and

FIG. 7 is a view illustration a control method for parking release of the electromechanical brake system according to one embodiment of the present disclosure.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

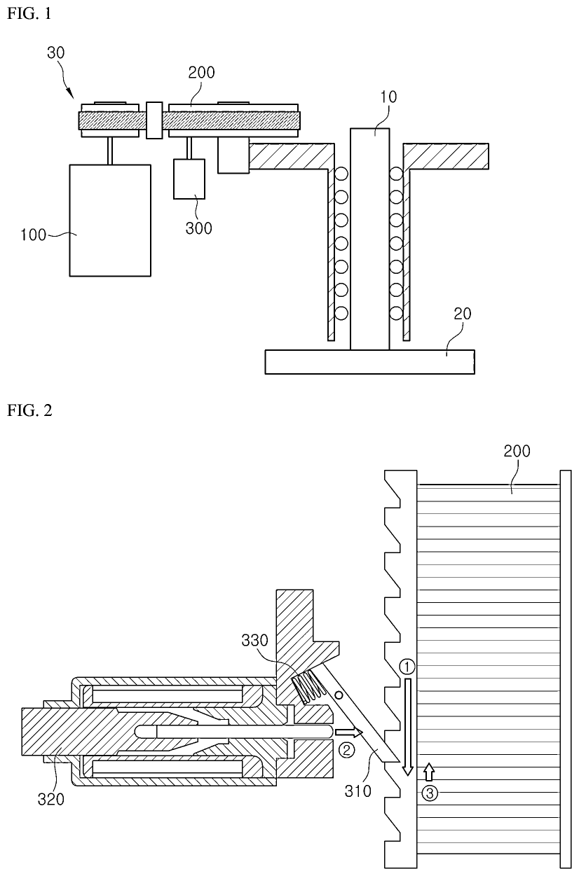

FIG. 1 is a view illustrating an electromechanical brake system according to one embodiment of the present disclosure.

Referring to FIG. 1, the electromechanical brake system may include a carrier (not shown) in which a pair of pad plates are installed to press a disk rotating with a wheel of a vehicle, a caliper housing (not shown) slidably movably installed on the carrier to actuate the pair of pad plates, a piston 20 installed to advance and retract inside the caliper housing, a brake actuator 30 that generates rotational driving force from a driving motor 100 and includes a reduction gear, a power transmitter 10 that receives rotational driving force provided by the brake actuator 30 and converts it to linear motion to transfer to the piston 20, thereby implementing axial advancing and retracting motion of the piston 20, a parking actuator 300 connected to the brake actuator 30 to implement parking braking, and a controller (ECU, not shown) configured to control the brake actuator 30 and the parking actuator 300.

The pair of pad plates are provided with brake pads attached to each of the inner surfaces. The pair of pad plates are slidably movably installed on the carrier, and consists of an inner pad plate, which is arranged to have its outer surface in contact with the forward surface (lower surface in FIG. 1) of the piston 20, and an outer pad plate, which is arranged to have its outer surface in contact with the finger portion of the caliper housing.

The caliper housing includes a finger portion for actuating the outer pad plate, a cylinder portion in which the piston is installed, and is slidably movably coupled to the carrier. As the caliper housing slides off the carrier and is moved toward the disk by a reaction force caused by movement of the piston 20 during braking of the vehicle, the outer pad plate can be approached toward the disk by the finger portion to press the disk.

The brake actuator 30 is a device that transmits rotational driving force to the piston 20 to move the piston 20 to implement normal braking and parking braking of the vehicle.

The brake actuator 30 includes the driving motor 100 that generates rotational driving force, and a reduction gear portion that is connected to the driving motor 100 and adjusts a gear ratio to slow down the speed but amplify the torque. In this case, the reduction gear portion may include a drive gear coupled to a rotational shaft of the driving motor 100, and the reduction gear connected to the drive gear to transmit power to the power transmitter 10. The drive gear and the reduction gear may be intermeshing via gear tooth, or may be connected by a gear belt. Further, the reduction gear may be connected to a spindle unit and a parking gear.

The power transmitter 10 may include a nut unit that rotates in connection with the reduction gear portion, and the spindle unit that is screwed to the nut unit to advance and retract in the piston.

Alternatively, in another embodiment, the power transmitter 10 may include the spindle unit that rotates in connection with the reduction gear portion and a nut unit that is screwed to the spindle unit to advance and retract in the piston.

The parking actuator 300 is a device connected to the brake actuator 30 to maintain a braking state of the vehicle, such that the braking state is maintained by locking the parking gear 200 provided in the brake actuator 30 while the piston presses the pad plate. More specifically, it is an apparatus that operates to maintain the braking state by locking the parking gear 200 provided in the reduction gear portion when the brake actuator 30 is actuated so that the brake pads are pressed against the disk by the piston pressing the pad plate during parking braking of the vehicle.

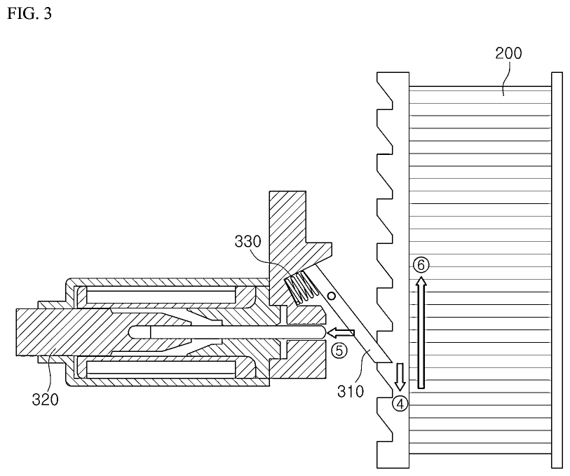

FIG. 2 is a view illustrating a parking engagement of the parking actuator of the electromechanical brake system according to one embodiment of the present disclosure, and FIG. 3 is a view illustrating a parking release of the parking actuator of the electromechanical brake system according to one embodiment of the present disclosure.

Referring to FIGS. 2 and 3, the parking actuator 300 may include a parking lever 310 engage-ably arranged with the parking gear 200 hinged on one side and arranged on the brake actuator 30 on the other side, a solenoid 320 to generate power, and a spring 330 to disengage the parking lever 310 from the parking gear 200.

Here, actuating the parking actuator 300 to lock the parking gear 200 to maintain the parking braking state is referred to as engagement, and actuating the parking actuator 300 to unlock the parking gear 200 is referred to as release.

The parking gear 200 is arranged on the reduction gear portion to rotate together when the reduction gear portion rotates and to be locked together when the reduction gear portion is locked. Preferably, the parking gear 200 is coaxially connected to the reduction gear and is arranged to rotate with the reduction gear, or may be integrally formed with the reduction gear. However, various variations are possible, such as the parking gear 200 being directly connected to the driving motor 100, or being provided on a different axis through another gear separate from the reduction gear, and should be understood to be the same as in the present embodiment if it is provided on the brake actuator 30 such that the brake actuator 30's actuation is limited when the parking gear 200's rotation is limited.

The parking gear 200 may be provided with a plurality of teeth to be engageable with the parking lever 310.

The parking lever 310 is engage-ably arranged with the parking gear 200 hinged on one side and rotatable on the other side toward the parking gear 200. Specifically, the parking lever 310 may be securely hinged by a pivot pin that is inserted into a housing surrounding the parking actuator 300.

The solenoid 320 generates power to drive the parking actuator 300. In this case, the solenoid 320 need only provide enough power to depress the parking lever 310, so it can be a low-powered solenoid.

The spring 330 disengages the parking lever 310 from the parking gear 200. The spring 330 may be provided in the form of a compression spring on one side of the parking lever 310 to support the parking lever 310 elastically. The spring 330 may be pressurized by the solenoid 320 to support the parking lever 310 engaged with the parking gear 200 to provide elastic force to the parking lever 310 such that upon retraction of the solenoid 320, the parking lever 310 is disengaged from the parking gear 200 to release the parking brake.

The spring 330 may further be provided in the form of a torsion spring that is inserted into the pivot pin of the parking lever 310 to support the parking lever 310 elastically. In this case, the torsion spring may have one end secured to the housing and the other end supported on the parking lever 310 to provide elastic force to the parking lever 310 so that upon retraction of the solenoid 320, the parking lever 310 is disengaged from the parking gear 200 to release the parking brake.

As illustrated in FIG. 2, in the parking engagement mode, operation of the brake actuator 30, which receives an electrical signal from the controller, causes the piston 20 to press the pad plate to implement parking braking. For example, the driving force of the brake actuator 30 presses the pad plate through the power transmitter 10, the piston 20, and the brake pads installed on the pad plates presses the disk, so that the vehicle wheel is parking braked.

At this time, the parking gear 200 provided on the brake actuator 30 is rotated in the forward direction by the drive of the driving motor 100 (\textcircled{1}).

In such a parking braking state, the controller operates the parking actuator 300 to perform a park-on operation to maintain the parking braking state.

Specifically, the controller advances the solenoid 320 to depress the parking lever 310 (\textcircled{2}). As the solenoid 320 pressurizes the parking lever 310, the parking lever 310 rotates toward the parking gear 200 and engages a gear tooth of the parking gear 200. That is, the parking gear 200 is fixed by the parking lever 310, and its rotation is limited, thereby limiting the operation of the brake actuator 30, including the reduction gear portion connected with the parking gear 200.

Then, as the torque of the driving motor 100 is released, the parking lever 310 is fully engaged with the gear tooth of the parking gear 200 so that the parking gear 200 can be somewhat rotated in the retraction direction (\textcircled{3}).

On the other hand, as shown in FIG. 3, since the parking lever 310 is engaged and pressed against the gear tooth of the parking gear 200 in the parking release mode, reversing the solenoid 320 does not immediately disengage the parking lever 310 from the parking gear 200.

Therefore, in the parking release mode, the parking gear 200 is rotated in the forward direction by operation of the brake actuator 30 receiving an electrical signal from the controller (\textcircled{4}). By such rotation of the parking gear 200, the parking lever 310 and the parking gear 200 may be spaced apart.

After the parking gear 200 rotates in the forward direction, the solenoid 320, which receives an electrical signal from the controller, moves backward (\textcircled{5}). When the solenoid 320 moves backward, the elastic force of the spring 330 causes the parking lever 310 to rotate and disengage from the gear tooth of the parking gear 200, thereby unlocking the parking gear 200 and allowing the parking gear 200 to rotate in the backward direction. As the parking gear 200 is unlocked, operation of the brake actuator 30, such as the reduction gear portion, becomes possible, and the braking state of the vehicle can be released by driving the brake actuator 30 in the retracting direction.

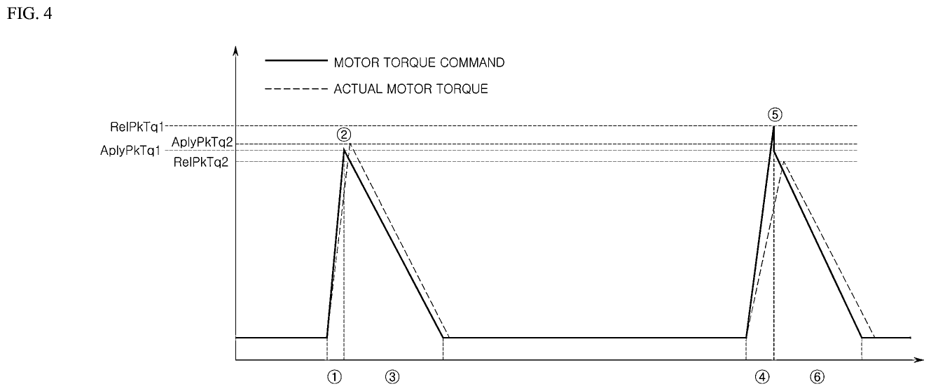

FIG. 4 is a view illustrating motor toque over time during parking engagement and release of the electromechanical brake system according to one embodiment of the present disclosure.

FIG. 4 illustrates motor torque during parking engagement and release of the electromechanical brake system as described above.

Referring to FIG. 4, in the electromechanical brake system, the controller drives the driving motor 100 forward until the torque of the driving motor 100 during parking engagement becomes a predetermined target engagement peak torque (AplyPKTq1) (\textcircled{1}).

Then, when the torque of the driving motor 100 reaches the target engagement peak torque (AplyPKTq1), the controller controls the parking actuator 300 to engage (\textcircled{2}).

Once the parking actuator 300 is engaged, the controller releases the torque on the driving motor 100 (\textcircled{3}).

Further, in the electromechanical brake system, the controller drives the driving motor 100 forward until the torque of the driving motor 100 during parking release is the target release peak torque (RelPKTq1) (\textcircled{4}). At this time, the target release peak torque (RelPKTq1) is set higher than the target engagement peak torque (AplyPKTq1) so that the engaged parking actuator 300 can be released.

Then, when the torque of the driving motor 100 reaches the target release peak torque (RelPkTq1), the controller controls the parking actuator 300 to engage (\textcircled{5}).

After the parking actuator 300 is engaged, the controller drives the driving motor 100 backward (\textcircled{6}).

In other words, the controller controls the driving motor 100 according to the motor torque command as illustrated in FIG. 4 so that parking engagement and parking release are performed.

However, despite the motor torque command of the controller, the torque of the driving motor 100 may be different.

When the controller drives the driving motor 100 forward until the torque of the driving motor 100 becomes the predetermined target peak torque (AplyPKTq1) during parking engagement (\textcircled{1}), the rotational inertia of the driving motor 100 causes the torque of the driving motor 100 to rise to an actual parking peak torque (AplyPKTq2) beyond the predetermined target peak torque (AplyPKTq1). If the parking actuator 300 is engaged (\textcircled{2}) at such an excessive actual parking peak torque (AplyPKTq2), there is a high probability that the parking actuator 300 will not be released during parking release.

Also, during parking release, the controller drives the driving motor 100 forward until the torque of the driving motor 100 becomes the target release peak torque (RelPKTq1) (\textcircled{4}), If the drive delay of the driving motor 100 is large such that the torque of the driving motor 100 does not reach the predetermined target release peak torque (RelPKTq1) and only rises to the actual release peak torque (RelPKTq2), the parking lever 310 of the parking actuator 300 may not be disengaged from the parking gear 200.

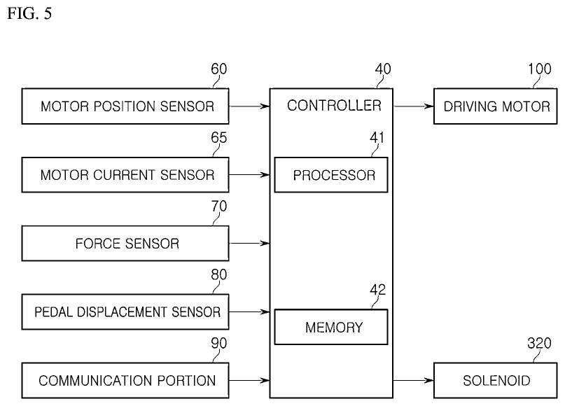

FIG. 5 is a view illustrating a control block of the electromechanical brake system according to one embodiment of the present disclosure.

Referring to FIG. 5, the electromechanical brake system may include a controller 40 that performs overall control.

The controller 40 may include a motor position sensor 60, a motor current sensor 65, a force sensor 70, and a pedal displacement sensor 80 electrically connected to the controller 40.

A communication portion 90 may be electrically connected to the controller 40.

The controller 40 may output signals to drive the driving motor 100 and the solenoid 320.

The motor position sensor 60 may detect a rotational position of the driving motor 100. The motor position sensor 60 may output an electrical signal corresponding to the detected rotational position.

The motor current sensor 65 may detect a drive current supplied to the driving motor 100. The motor current sensor 65 may output an electrical signal corresponding to a value of the detected drive current.

The force sensor 70 may detect a clamping force due to contact between the disk mounted on the wheel and the brake pad. The force sensor 70 may output an electrical signal corresponding to a value of the detected clamping force.

The pedal displacement sensor 80 may detect the displacement of a brake pedal provided in the vehicle. The pedal displacement sensor 80 may output an electrical signal corresponding to the displacement of the brake pedal.

The communication portion 90 may send and receive communication signals to and from the electromechanical brake system and the driver assistance system mounted on the vehicle via an in-vehicle communication network. The communication portion 90 may include a CAN transceiver.

The controller 40 may be named an electronic control unit (ECU).

The controller 40 may include a processor 41 and a memory 42.

The memory 42 may store programs for processing or controlling the processor 41 and various data for operating the electromechanical brake system.

Memory 42 may include volatile memory, such as S-RAM and D-RAM, as well as non-volatile memory, such as flash memory, read only memory (ROM), and erasable programmable read only memory (EPROM).

The processor 41 may control the overall operation of the electromechanical brake system.

The controller 40 with the above configuration may cause the driving motor 100 to rotate forward or reverse. The controller 40 may include an H-Bridge circuit comprising a plurality of power switching elements to rotate and reverse the driving motor 100.

The controller 40 rotates the driving motor 100 in one direction in the parking engagement mode. The unidirectional direction is referred to herein as the forward direction. The forward rotation of the driving motor 100 is decelerated by passing through the reduction gear portion, which can rotate the nut unit in the forward direction with a large force. When the nut unit is rotated in the forward direction, axial movement of the spindle unit can occur. When the spindle unit presses the piston 20, the brake pads installed on the pad plate may press the disk to brake the wheel.

Alternatively, in another embodiment, forward rotation of the driving motor 100 may rotate the spindle unit in a forward direction with a large force, and axial movement of the nut unit may be accomplished by forward rotation of the spindle unit. When the nut unit presses the piston 20, the brake pads installed on the pad plate may press the disk to brake the wheel.

The parking release mode may operate in reverse of the parking engagement mode.

The controller 40 may perform the parking engagement mode or the parking release mode by an operation signal of the parking switch operated by the driver or by an operation signal generated by a program associated with the operation of the electronic parking brake.

The controller 40 may determine a target engagement clamping force in the parking engagement mode. The controller 40 may determine the target engagement clamping force based on an operation signal of the parking switch or a detection signal corresponding to a brake pedal displacement detected via the pedal displacement sensor 80. In addition, the controller 40 may determine the target engagement clamping force required for parking using the parking switch operation, the brake pedal displacement, the wheel speed received via the communication portion 90, the vehicle weight, the road surface slope, and the like. In addition, the controller 40 may receive the target engagement clamping force directly through the communication portion 90.

The controller 40 drives the driving motor 100 in the forward direction in the parking engagement mode.

The controller 40 can drive the driving motor 100 in the forward direction until the target engagement clamping force is reached in the parking engagement mode.

The controller 40 may perform an engagement operation of the parking actuator 300 based on the current clamping force in the parking engagement mode. For example, the controller 40 may estimate the clamping force based on the drive current of the driving motor 100 detected via the motor current sensor 65 in the parking engagement mode, and control the parking actuator 300 to engage when the estimated clamping force reaches the target engagement clamping force. In another example, the controller 40 may control the parking actuator 300 to engage when the clamping force detected via the force sensor 70 in the parking engagement mode reaches the target engagement clamping force.

In the parking engagement mode, the controller 40 advances the solenoid 320 to engage the parking lever 310 to engage the parking gear 200 to perform an engagement operation that locks the parking gear 200 to maintain the parking braking state.

At this time, the controller 40 detects the position of the driving motor 100 and stores it as a parking motor position. The controller 40 may receive the position of the driving motor 100 detected by the motor position sensor 60, or may store the estimated position of the driving motor 100 received via the communication portion 90 as the position of the driving motor 100.

The controller 40 may store the parking motor position and use it as a release condition for the parking actuator 300 in the parking release mode to prevent the parking lever 310 from jamming when the parking actuator 300 is released.

The controller 40 may recall the stored parking motor position in the parking release mode.

The controller 40 may determine a target release clamping force in the parking release mode. The controller 40 may derive the target release clamping force based on the target engagement clamping force determined in the parking engagement mode. Preferably, the target release clamping force may be determined to be a higher value than the target engagement clamping force. For example, the target release clamping force may be determined as a value that is a predetermined percentage higher than the target engagement clamping force (e.g., 1.2 times the target engagement clamping force), or the target release clamping force may be determined as a value that is a predetermined difference higher than the target engagement clamping force (e.g., the target engagement clamping force plus a predetermined clamping force).

The controller 40 drives the driving motor 100 in a forward direction in the parking release mode.

The controller 40 may drive the driving motor 100 in the forward direction until the target release clamping force is reached in the parking release mode.

In one embodiment, the controller 40 may perform a release operation of the parking actuator 300 based on the current clamping force in the parking release mode. For example, the controller 40 may estimate the clamping force based on the drive current of the driving motor 100 detected via the motor current sensor 65 in the parking release mode, and control the parking actuator 300 to release when the estimated clamping force reaches the target release clamping force. In another example, the controller 40 can be controlled to release the parking actuator 300 when the clamping force detected via the force sensor 70 in the parking release mode reaches the target release clamping force.

In other embodiments, the controller 40 may perform the release operation of the parking actuator 300 based on the current motor position in the parking release mode. The controller 40 may detect the position of the driving motor 100 in the parking release mode and control the parking actuator to release when the detected position of the driving motor 100 reaches the parking motor position.

In another embodiment, the controller 40 may perform a release operation of the parking actuator 300 based on the current clamping force and the current motor position in the parking release mode. The controller 40 may detect the current motor position of the driving motor 100 when the estimated clamping force or the detected clamping force is above the target release clamping force, and may control to release the parking actuator 300 when the detected position of the driving motor 100 reaches the parking motor position.

The controller 40 releases the parking brake by retracting the solenoid 320 in the parking release mode to perform a release operation that causes the parking lever 310 to disengage from the parking gear 200, thereby unlocking the parking gear 200.

The controller 40 controls the parking actuator 300 to release in the parking release mode, and then drives the driving motor 100 in the reverse direction. By rotating the driving motor 100 in the reverse direction, the pressurization of the piston 20 is released, and the brake pads installed on the pad plate are spaced apart from the disk, so that the braking of the wheel can be released.

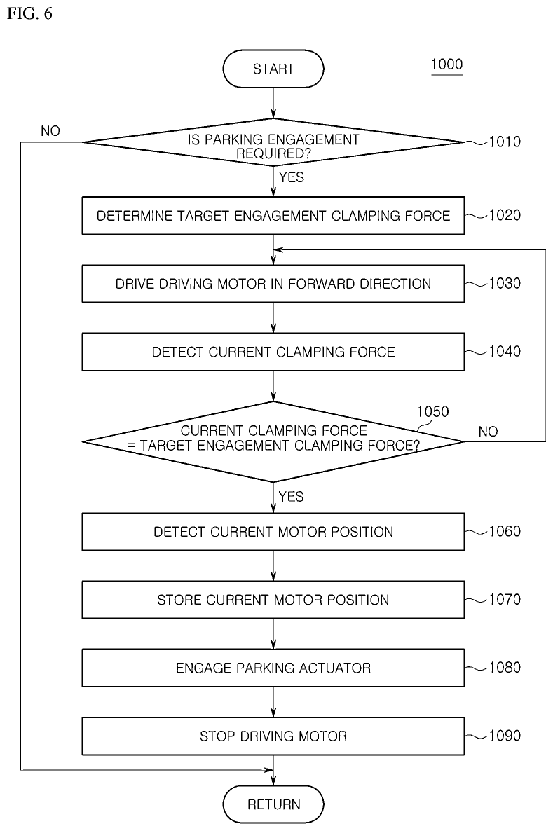

FIG. 6 is a view illustration a control method for parking engagement of the electromechanical brake system according to one embodiment of the present disclosure.

Referring to FIG. 6, a parking engagement control method S1000 of the electromechanical brake system according to one embodiment may include determining whether initiation of parking engagement is required S1010, determining a target engagement clamping force S1020, driving the driving motor 100 in a forward direction S1030, and detecting a current clamping force S1040, determining whether the current clamping force has reached a target engagement clamping force S1050, and detecting a current motor position when the current clamping force reaches the target engagement clamping force S1060, storing the detected current motor position as a parking motor position S1070, controlling the parking actuator 300 to engage S1080, and stopping the driving motor 100 S1090.

The controller 40 determines whether parking initiation of parking engagement is required. The controller 40 may determine that initiation of parking engagement is required when the parking switch is operated by the driver, or when initiation of parking engagement is requested by a program associated with operating the electromechanical brakes.

When the controller 40 determines that the initiation of parking engagement is required, the controller 40 determines a target engagement clamping force required for parking based on an operation signal of the parking switch or a detection signal corresponding to a brake pedal displacement detected via the pedal displacement sensor 80. The controller 40 may also determine the target engagement clamping force required for parking using the parking switch operation, brake pedal displacement, wheel speed received via the communication portion 90, vehicle weight, road surface slope, and the like.

The controller 40 performs the parking engagement mode to drive the driving motor 100 in the forward direction to generate the determined target engagement clamping force. The controller 40 rotates the driving motor 100 in the forward direction to press the piston 20 through the spindle unit and the nut unit to press the brake pads against the disk to brake the wheel.

The controller 40 estimates the current clamping force through the motor current sensor 65 or detects the current clamping force through the force sensor 70 when performing the parking engagement mode.

The controller 40 determines whether the current clamping force has reached the target engagement clamping force.

When the current clamping force reaches the target engagement clamping force, the controller 40 detects the current motor position, stores the detected current motor position as the parking motor position, and advances the solenoid 320 for the parking engagement operation.

The controller 40 detects the position of the driving motor 100 and stores it as the parking motor position. The controller 40 may receive the position of the driving motor 100 detected by the motor position sensor 60, or may store an estimated position of the driving motor 100 received via the communication position 90 as the position of the driving motor 100.

The controller 40 maintains the parking braking state by advancing the solenoid 320 to engage the parking lever 310 to the parking gear 200, thereby performing an engagement operation to secure the parking gear 200.

The controller 40 stops the driving motor 100 after performing the engagement operation of the parking actuator 300. When the driving motor 100 stops and the torque of the driving motor 100 becomes low, the parking gear 200 rotates somewhat in the retraction direction, and the parking lever 310 is strongly engaged between the gear tooth of the parking gear 200, and locking is performed.

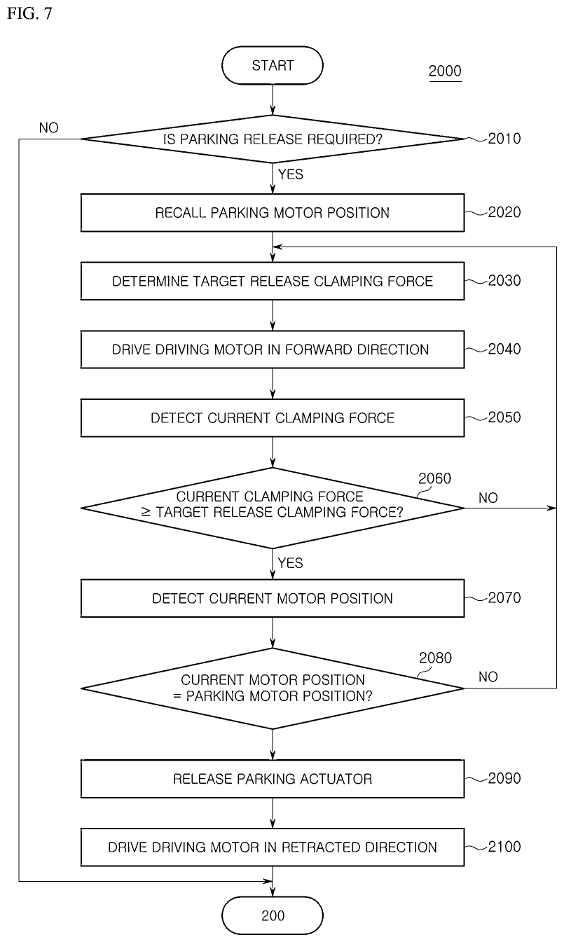

FIG. 7 is a view illustration a control method for parking release of the electromechanical brake system according to one embodiment of the present disclosure.

Referring to FIG. 7, a control method S2000 at the time of unparking of an electromechanical brake system according to one embodiment may include determining whether the initiation of parking release is required S2010, recalling a stored parking motor position S2020, determining a target release clamping force S2030, driving the driving motor 100 in a forward direction S2040, detecting a current clamping force S2050, determining whether the current clamping force has reached the target release clamping force S2060, detecting the current motor position when the current clamping force reaches the target release clamping force S2070, determining whether the current motor position reaches the parking motor position S2080, controlling the parking actuator 300 to release when the current motor position reaches the parking motor position S2090, and driving the driving motor 100 in the retracted direction S2100.

The controller 40 determines whether the initiation of parking release is required. The controller 40 may determine that the initiation of parking release is required when the parking switch is operated by the driver, or when initiation of parking release is requested by a program associated with operation of the electromechanical brakes.

When the controller 40 determines that the initiation of parking release is required, the controller 40 recalls the parking motor position stored in the parking engagement mode.

The controller 40 determines the target release clamping force required for release based on the target engagement clamping force determined in the parking engagement mode. Preferably, the target release clamping force may be determined to be a higher value than the target engagement clamping force.

To generate the determined target release clamping force, the controller 40 performs the parking release mode to drive the driving motor 100 in the forward direction. The controller 40 rotates the driving motor 100 in the forward direction to relieve the force between the parking lever 310 and the parking gear 200 so that the parking lever 310 can be disengaged from the parking gear 200.

When performing the parking release mode, the controller 40 estimates the current clamping force via the motor current sensor 65 or detects the current clamping force via the force sensor 70.

The controller 40 determines whether the current clamping force has reached the target release clamping force.

When the current clamping force reaches the target engagement clamping force, the controller 40 detects the current motor position and determines whether the current motor position reaches the parking motor position.

When the current motor position reaches the parking motor position, the controller 40 retracts the solenoid 320 for the parking release operation. The controller 40 releases the parking braking state by retracting the solenoid 320 to perform the release operation that causes the parking lever 310 to disengage from the parking gear 200 by the elastic force of the spring 330 to unlock the parking gear 200.

The control part 40 drives the driving motor 100 in the reverse direction after performing the release operation of the parking actuator 300. By rotating the driving motor 100 in the reverse direction, the pressurization of the piston 20 is released, and the brake pads installed on the pad plate are spaced apart from the disk, so that the braking of the wheel can be released.

According to one aspect of the present disclosure, a brake device that implements braking and parking of a vehicle by power of a motor and a control method thereof can be provided.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A brake device, comprising:
a power transmitter configured to advance or retract a piston to press a pair of pad plates, to which brake pads are attached, toward a disk;
a driving motor configured to provide rotational force to the piston;
a parking actuator connected to the driving motor to maintain parking braking state of a vehicle; and
a controller configured to:
control the driving motor and the parking actuator, and
control the parking actuator based on a rotational position of the driving motor and a clamping force due to contact of the disk with the brake pads.

2. The brake device of claim 1, further comprising:
a force sensor configured to detect the clamping force due to contact of the disk with the brake pads.

3. The brake device of claim 1, further comprising a motor current sensor configured to detect a drive current of the driving motor,
wherein the controller is configured to estimate the clamping force based on the drive current.

4. The brake device of claim 1, wherein the controller is configured to:
control the parking actuator to engage when the clamping force reaches a target engagement clamping force in parking engagement mode, and
detect and store a position of the driving motor as parking motor position.

5. The brake device of claim 4, wherein the controller is configured to drive the driving motor in a forward direction in parking release mode.

6. The brake device of claim 5, wherein the controller is configured to control the parking actuator to release when the clamping force reaches a target release clamping force in parking release mode.

7. The brake device of claim 6, wherein the target release clamping force is greater than the target engagement clamping force.

8. The brake device of claim 5, wherein the controller is configured to:
detect the position of the driving motor in parking release mode, and
control the parking actuator to release when the position of the driving motor reaches the parking motor position.

9. The brake device of claim 5, wherein the controller is configured to:
detect the position of the driving motor in parking release mode when the clamping force reaches the target release clamping force and control the parking actuator to release when the detected position of the driving motor reaches the parking motor position.

10. The brake device of claim 5, wherein the controller is configured to drive the driving motor in a backward direction after controlling the parking actuator to release in parking release mode.

11. A method of controlling a brake device including a power transmitter configured to advance or retract a piston to press a pair of pad plates, to which brake pads are attached, toward a disk, a driving motor configured to provide rotational force to the piston and a parking actuator connected to the driving motor to maintain parking braking state of a vehicle, comprising:
obtaining a clamping force due to contact of the disk with the brake pads; and
controlling the parking actuator based on the clamping force and a rotational position of the driving motor.

12. The method of controlling the brake device of claim 11, wherein the obtaining of the clamping force comprises obtaining the clamping force through a force sensor configured to detect the clamping force due to contact of the disk with the brake pads.

13. The method of controlling the brake device of claim 11, wherein the obtaining of the clamping force comprises:
detecting a drive current of the driving motor through a motor current sensor and
estimating the clamping force based on the drive current.

14. The method of controlling the brake device of claim 11, wherein the controlling of the parking actuator comprises controlling the parking actuator to engage when the clamping force reaches a target engagement clamping force in parking engagement mode.

15. The method of controlling the brake device of claim 14, wherein the controlling of the parking actuator comprises driving the driving motor in a forward direction in parking release mode.

16. The method of controlling the brake device of claim 15, wherein the controlling of the parking actuator comprises controlling the parking actuator to release when the clamping force reaches a target release clamping force in parking release mode.

17. The method of controlling the brake device of claim 16, wherein the target release clamping force is greater than the target engagement clamping force.

18. The method of controlling the brake device of claim 16, wherein the controlling of the parking actuator comprises:
detecting the position of the driving motor in parking release mode and
controlling the parking actuator to release when the position of the driving motor reaches the parking motor position.

19. The method of controlling the brake device of claim 16, wherein the controlling of the parking actuator comprises:
detecting the position of the driving motor in parking release mode when the clamping force reaches the target release clamping force and
controlling the parking actuator to release when the position of the driving motor reaches the parking motor position.

20. The method of controlling the brake device of claim 19, wherein the controlling of the parking actuator comprises driving the driving motor in a backward direction after controlling the parking actuator to release in parking release mode.
